(19) United States
(12) Patent Application Publication
(10) Pub. No.: US 2005/0094584 A1
(43) Pub. Date: May 5, 2005

(54) Architecture for a wireless local area network physical layer

(75) Inventors: Wolfram Kluge, Dresden (DE); Dietmar Eggert, Dresden (DE); Jorg Borowski, Dresden (DE); Lutz Dathe, Dresden (DE)

Correspondence Address: MEYERTONS, HOOD, KIVLIN, KOWERT & GOETZEL, P.C., P.O. BOX 398, AUSTIN, TX, 78767-0398, US

(73) Assignee: Advanced Micro Devices, Inc.

(21) Appl. No.: 10/701,116

(22) Filed: Nov. 4, 2003

(51) Int. Cl. H04B 7/00

(52) U.S. Cl. 370/310; 370/366

(57) ABSTRACT

In one embodiment, an apparatus comprises a first integrated circuit and a second integrated circuit configured to be coupled to the first integrated circuit. The first integrated circuit comprises transceiver hardware configured to transmit and receive analog signals, one or more analog to digital converters coupled to the transceiver hardware, and one or more digital to analog converters coupled to the transceiver hardware. The analog to digital converters are configured to convert one or more received analog signals from the transceiver hardware to one or more received digital signals. The digital to analog converters are coupled to receive one or more transmitted digital signals, and are configured to convert the transmitted digital signals to transmitted analog signals for transmission by the transceiver hardware. The second integrated circuit comprises a baseband processor configured to process the received digital signals and to generate the transmitted digital signals.

### BACKGROUND OF THE INVENTION

1. Field of the Invention

This invention is related to integrated circuits for wireless communication such as wireless networking.

2. Description of the Related Art

A wireless local area network (LAN) system is a flexible data communication system that allows a remote user's mobile device to connect to an access point of the network (wired LAN), without having the requirement for the mobile device of being physically attached to the network, as well as to connect to another remote device. Thus the mobile device in a wireless LAN system provides for wireless mobility and additionally achieves the common functionality of wired data transfer as well as application and data access via the wireless network.

Presently, Radio Frequency (RF) and Infra Red (IR) transmission techniques are most commonly used in wireless LANs. For example, the industry specification Institute for Electrical and Electronic Engineers (IEEE) 802.11 (and its extension to 802.11b) provides a standard for wireless LAN systems and products and describes direct sequence spread spectrum (DSSS) as one possible modulation technique for RF signals.

Typically, chipsets used for wireless LAN devices (and other wireless communication devices) include an RF chip and a digital signal processing (DSP) chip. The interface between the RF chip and the DSP chip is analog (that is, analog signals are exchanged between the RF chip and the DSP chip, transmitted on the circuit board to which the RF chip and the DSP chip are attached). Unfortunately, the analog signals are exposed to digital switching noise and other noise sources in the transmission between the RF chip and the DSP chip. Additionally, the RF chip includes various analog circuitry that involves setting gain based on feedback (e.g. amplifiers, filters, etc.). Typically, the gain is controlled by the DSP chip. Such a configuration requires a feedback loop that crosses chip boundaries, which may increase the gain settling time when the gain is changed due to changes in the feedback.

### SUMMARY OF THE INVENTION

In one embodiment, an apparatus comprises a first integrated circuit and a second integrated circuit configured to be coupled to the first integrated circuit. The first integrated circuit comprises transceiver hardware configured to transmit and receive analog signals, one or more analog to digital converters coupled to the transceiver hardware, and one or more digital to analog converters coupled to the transceiver hardware. The analog to digital converters are configured to convert one or more received analog signals from the transceiver hardware to one or more received digital signals. The digital to analog converters are coupled to receive one or more transmitted digital signals, and are configured to convert the transmitted digital signals to transmitted analog signals for transmission by the transceiver hardware. The second integrated circuit comprises a baseband processor configured to process the received digital signals and to generate the transmitted digital signals.

In another embodiment, an apparatus comprises a digital interface, a first integrated circuit coupled to the digital interface, and a second integrated circuit coupled to the digital interface. The first integrated circuit comprises transceiver hardware configured to transmit and receive analog signals, and the first integrated circuit is configured to transmit and receive corresponding digital signals on the digital interface. The second integrated circuit comprises a baseband processor configured to process one or more digital signals received on the digital interface from the first integrated circuit and to transmit one or more digital signals on the digital interface to the first integrated circuit.

### BRIEF DESCRIPTION OF THE DRAWINGS

The following detailed description makes reference to the accompanying drawings, which are now briefly described.

FIG. 1 is a block diagram of one embodiment of a wireless networking card.

FIG. 2 is a block diagram of one embodiment of an RF integrated circuit shown in FIG. 1.

FIG. 3 is a block diagram of one embodiment of a digital integrated circuit shown in FIG. 1.

FIG. 4 is a block diagram of one embodiment of a computer system including the wireless networking card shown in FIG. 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Turning next to the drawings, an embodiment is described of a wireless networking card in a computer system (or the circuitry comprising the wireless networking card may be integrated onto the main circuit board (or mother board) of the computer system). However, it is noted that other embodiments may be used for any type of wireless or wired communication.

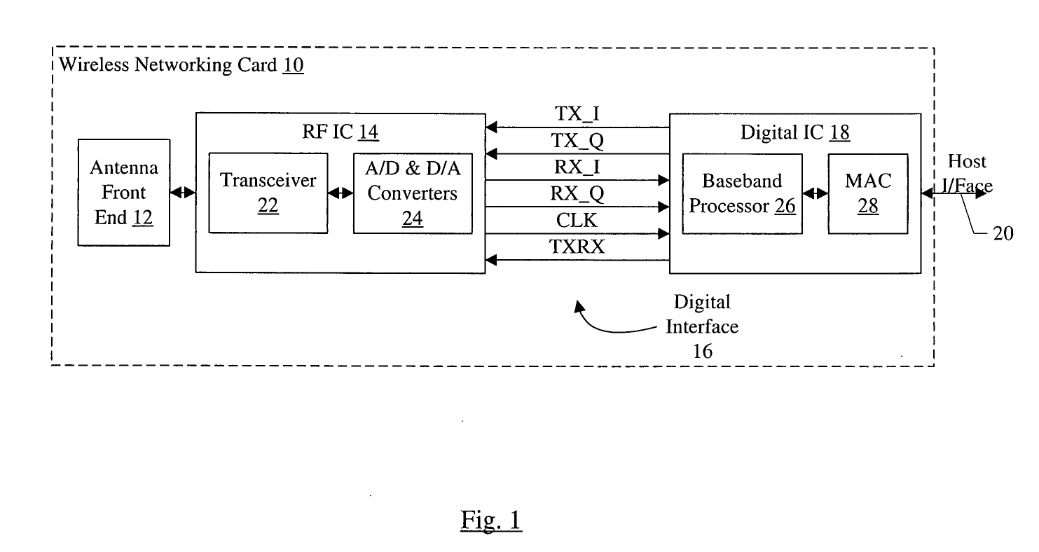

Turning now to FIG. 1, a block diagram of one embodiment of a wireless networking card 10 is shown. The wireless networking card 10 may comprise an antenna front end 12, an RF integrated circuit (IC) 14, a digital IC 18, and a digital interface 16 between the RF IC 14 and the digital IC 18. The antenna front end 12 is coupled to the RF IC 14, which is further coupled to the digital interface 16. The digital IC 18 is coupled to the digital interface 16 and to a host interface 20 to communicate with a host processor in a computer system that includes the wireless networking card 10. In the illustrated embodiment, the RC IC 14 includes transceiver hardware 22 and one or more analog to digital (A/D) and digital to analog (D/A) converters 24. In the illustrated embodiment, the digital IC 18 includes a baseband processor 26 and a media access controller (MAC) 28.

The transceiver hardware 22 is configured to transmit and receive analog signals from the antenna front end 12. That is, the analog signals are transmitted and received wirelessly using the antenna in the antenna front end 12. The antenna front end 12 may include, in addition to the antenna, an amplifier and/or a bandpass filter, if desired. The A/D converters 24 may receive one or more analog signals from the transceiver hardware 22 and may convert the received analog signals to one or more corresponding received digital signals. The received digital signals may be transferred over the digital interface 16 to the digital IC 18.

The baseband processor 18 may process the received digital signals, and may also generate one or more digital signals that correspond to analog signals to be transmitted by the transceiver hardware 22 (referred to as transmitted digital signals). The digital IC 18 may transfer the transmitted digital signals over the digital interface 16 to the RF IC 14. More particularly, the D/A converters 24 may receive the transmitted digital signals, and may convert the transmitted digital signals to corresponding transmitted analog signals. The transmitted analog signals may be provided to the transceiver hardware 22 for transmission.

Since the interface 16 is digital, the interface may be less sensitive to the digital switching noise and other noise sources that may exist on the wireless networking card 10. The card 10 may comprise a printed circuit board onto which the digital interface 16 is formed and to which the ICs 14 and 18 may be coupled. Using standard digital interfacing techniques, the effects of such noise may be minimized. A more robust system solution may thus be realized, in some embodiments. The analog signals, once received into the transceiver hardware 22, remain within the RF IC 14 and thus may be less exposed to the noise sources.

Additionally, since the digital IC 18 communicates digitally on the interface 16 and on the host interface 20, the digital IC 18 may have little or no analog circuitry. Accordingly, the digital IC 18 may be fabricated in an integrated circuit fabrication process that is optimized for digital circuitry (e.g. aggressively tuned to digital circuit creation). The RF IC 14 may be fabricated in an integrated circuit fabrication process that favors analog circuitry and permits digital circuitry.

In the illustrated embodiment, the wireless networking card 10 may employ a quadrature modulation scheme that divides the bit stream being transmitted into even and odd bit streams (e.g. quadrature phase shift keying (QPSK), offset QPSK (OQPSK), minimum shift keying (MSK), Gaussian MSK (GMSK), etc.). In such schemes, the bit stream to be transmitted on a signal may be divided into even and odd bit streams (e.g., if the bit stream is numbered beginning with 0 for the first bit in the stream and incrementing the numbering in the order the bits occur in the bit stream, bits 0, 2, 4, etc. are included in the even bit stream and bits 1, 3, 5, etc. are included in the odd bit stream). The even bit stream is labeled I (for in-phase) and the odd bit stream is labeled Q (for quadrature). Thus, the digital I and Q signals are shown for each of the transmit (TX) and receive (RX) directions in FIG. 1. That is, the transmitted in-phase digital signal is TX_I, and the transmitted quadrature digital signal is TX_Q. Similarly, the received in-phase digital signal is RX_I, and the received quadrature digital signal is RX_Q. The interface 16 also includes a clock signal to which the TX_I, TX_Q, RX_I, and RX-Q signals are referenced. A TXRX signal may be used to indicate the direction of transfer (transmit or receive). In other embodiments, the digital interface may include a single bit stream per transfer direction, or more than two, depending on the type of modulation to be used.

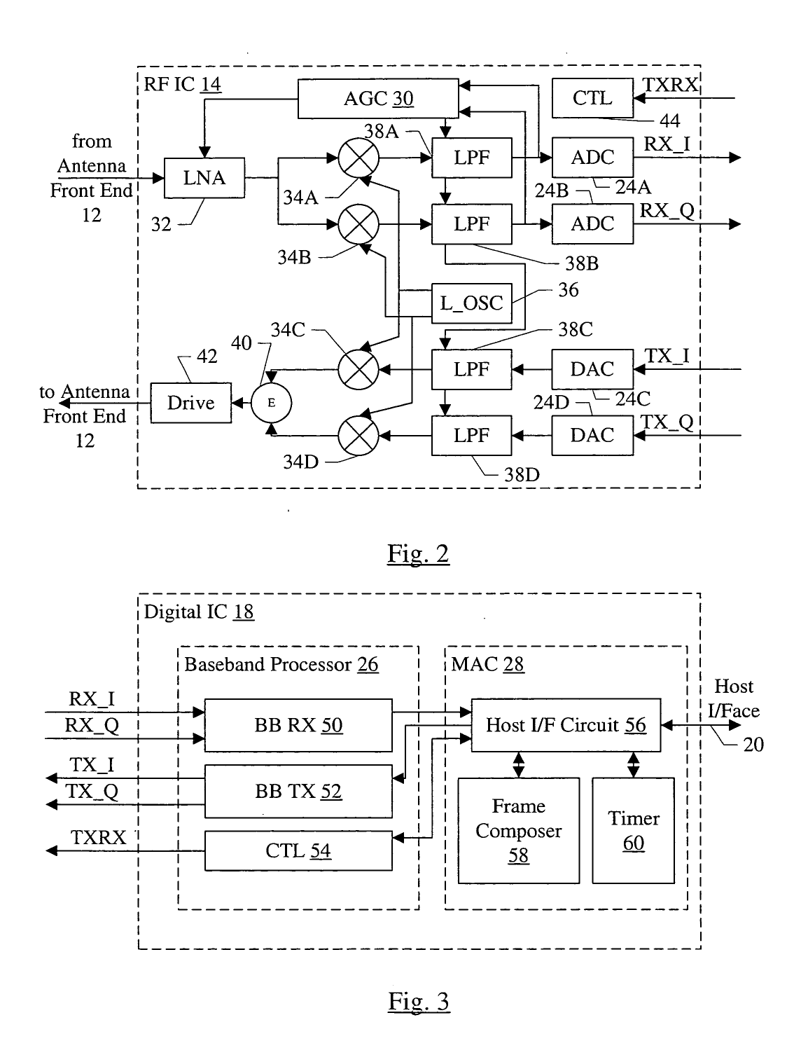

The transceiver hardware 22 may be any desired transceiver configuration. One example is shown in FIG. 2, but any hardware that transmits and receives analog signals may be used. In some embodiments, the wireless networking card 10 may be compatible with the IEEE 802.11 (and/or 802.11b) standards, and thus the transceiver hardware 22 may be configured to transmit and receive at frequencies indicated in the standards (e.g. 2.4 GHZ direct sequence spread spectrum (DSSS) signalling). Other embodiments may implement any frequencies, in any frequency range, as desired.

The baseband processor 26 receives the received digital signals from the digital interface 16 and processes the signals to generate the corresponding bit stream represented by the received digital signals. For example, in some embodiments, the baseband processor may decode the received digital signals according to the encoding scheme implemented by the wireless networking card 10. The decoding may further include correcting any errors that may have been introduced in the transmission of the bit stream to the wireless networking card 10. In one particular implementation, the baseband processor 26 may employ DSSS encoding. The baseband processor 26 may provide the bit stream to the MAC 28 for processing. Similarly, the baseband processor 26 receives a bit stream to be transmitted from the MAC 28, and may generate the transmitted digital signals for transfer on the digital interface 16 to the RF IC 14. For example, the baseband processor 26 may encode the bit stream according to the implemented encoding scheme.

Since the wireless networking card 10 is used for networking, the received and transmitted analog signals may represent frames communicated between devices using the wireless network. The digital IC 18 also includes the MAC 28 for performing some of the frame processing in hardware. Additionally, the MAC 28 may transmit the received frames (e.g. via direct memory access (DMA) on the host interface 20) to memory for further processing via software executing on a host processor in the computer system that includes the wireless networking card 10.

In some embodiments, the MAC 28 may handle communications that require a real-time response on the network and may leave other payload processing to the host processor. For example, the MAC 28 may handle one or more of sequencing of frames to be transmitted on the network, timing, channel management functions, control frame generation, generation of acknowledgements, and power management functions.

The host interface 20 may be any suitable interface for communicating with the host computer system. For example, the host interface 20 may be the PCI bus, the card bus, the universal serial bus (USB), firewire, HyperTransport™, etc.

While the present embodiment is described as a card (which may, e.g. be inserted into an expansion slot in a computer system), other embodiments may integrate the wireless network function onto the main circuit board (or motherboard) in the computer system. That is, the ICs 14 and 18 may be connected to the main circuit board, and the digital interface 16 may be implemented on the main circuit board.

As used herein, an “integrated circuit” may be a single piece of semiconductor substrate with circuitry formed thereon. The integrated circuit may be packaged in any desired packaging for making connection between the integrated circuit and a circuit board. As used herein, a “digital interface” comprises one or more lines on which digital signals are transmitted during use (that is, the signals transmit digital values).

Turning now to FIG. 2, a block diagram of one embodiment of the RF IC 14 in greater detail is shown. In the illustrated embodiment, the RF IC 14 includes analog to digital converters (ADCs) 24A-24B and digital to analog converters (DACs) 24C-24D. Converters 24A-24D may be part of the A/D and D/A converters 24 shown in FIG. 1. The remaining blocks shown in FIG. 2 may be part of the transceiver hardware 22 for this embodiment, and includes an automatic gain control circuit (AGC) 30, a low noise amplifier (LNA) 32, a set of mixers 34A-34D, a local oscillator 36, a set of low pass filters 38A-38D, a summation circuit 40, a drive circuit 42, and a control circuit 44. The control circuit 44 is coupled to receive the TXRX signal from the digital interface 16, and may be coupled to various other circuitry in FIG. 2. The AGC 30 is coupled to the outputs of the filters 38A-38B and to the LNA 32 and to provide input to at least some of the filters 38A-38D. The LNA 32 is coupled to receive the input analog signal from the antenna front end 12, and is coupled to the mixers 34A-34B. The mixers 34A-34B are respectively coupled to the filters 38A-38B, which are respectively coupled to the ADCs 24A-24B. The ADC 24A is coupled to the RX_I line of the digital interface 16, and the ADC 24B is coupled to the RX_Q line of the digital interface 16. Each of the mixers 34A-34D is coupled to the local oscillator 36. The DAC 24C is coupled to the TX_I line of the digital interface 16, and the DAC 24D is coupled to the TX_Q line of the digital interface 16. The filters 38C-38D are respectively coupled to the DACs 24C-24D and to the mixers 34C-34D. The output of the mixers 34C-34D are coupled to the summation circuit 40, which is further coupled to the driver circuit 42. The driver circuit 42 is further coupled to the antenna front end 12.

The LNA 32 receives the analog signal from the antenna front end 12, and may provide amplification of the analog signal. The gain of the LNA 32 may be set by the AGC circuit 30, based on monitoring the output of the filters 38A-38B. The amplified analog signal is provided to the mixers 34A-34B, which mix the signal with in-phase and quadrature local oscillator signals (respectively) from the local oscillator 36. The resulting signals may be baseband in-phase and quadrature analog signals (respectively), or may be relatively near baseband (as compared to the frequency of the local oscillator signal). The output of the mixers 34A-34B may be filtered in the filters 38A-38B (e.g. low pass filtering may be employed, with cutoff frequencies that may be controlled by the AGC circuit 30 in some embodiments). The filtered analog signals are provided to the ADC circuits 24A-24B, which convert the analog signals to digital signals for transmission on the RX_I and RX_Q lines, respectively.

Transmitted digital signals on the TX_I and TX_Q lines are received by the DACs 24C-24D, which convert the signals to corresponding analog signals for transmission. The converted analog signals are provided to the filters 38C-38D (e.g. low pass filtering may be employed, with cutoff frequencies that may be controlled by the AGC circuit 30, in some embodiments). The filtered analog signals are provided to mixers 34C-34D, which mix the signals with the in-phase and quadrature local oscillator signals, respectively. The resulting signals are summed in the summation circuit 40, and provided to the driver circuit 42 for transmission on the antenna front end 12.

The local oscillator 36 may comprise any circuitry for providing local oscillator signals (both in-phase and quadrature, where the quadrature is 90 degrees out of phase with the in-phase). For example, in one embodiment, the local oscillator 36 may comprise a phase locked loop and a voltage controlled oscillator.

The AGC circuit 30 may provide gain control for the LNA 32 (and control for at least some of the filters 38A-38D) using local feedback (that is, feedback from within the RF IC 14). Long feedback loops that cross integrated circuit boundaries may be avoided. Similarly, in some embodiments, the RF IC 14 may provide automatic TX power level control locally. Additional D/A and A/D converters to handle communication of feedback signals may also be avoided in the illustrated embodiment. Additional details regarding some embodiments of the AGC circuit 30 may be found in U.S. patent application Ser. No. 10/283,584, filed Oct. 30, 2002 and U.S. patent application Ser. No. 10/259,708, filed Sep. 27, 2002. These applications are incorporated herein by reference in their entireties, to the extent that no conflict exists between these applications and the present disclosure set forth herein. In the event of such conflict, then any such conflicting material in such incorporated by reference U.S. patent applications is specifically not incorporated by reference herein.

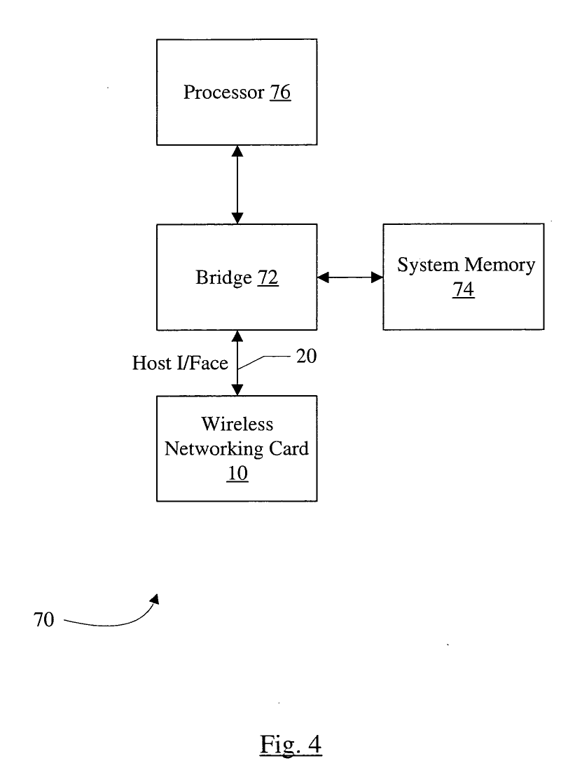

Turning now to FIG. 3, a block diagram illustrating one embodiment of the digital IC 18 in greater detail is shown. In the illustrated embodiment, the baseband processor 26 includes a baseband receive circuit (BB RX) 50, a baseband transmit circuit (BB TX) 52, and other control circuitry 54. The MAC 28 may include a host interface (I/F) circuit 56, a frame composer circuit 58, and a timer circuit 60. The BB RX circuit 50 is coupled to the RX_I and RX_Q lines of the digital interface 16, and is coupled to the host interface circuit 56. The BB TX circuit 52 is coupled to the TX_I and TX_Q lines of the digital interface 16, and to the host interface circuit 56. The control circuit 54 is coupled to the TXRX line of the digital interface 16 and to the host interface circuit 56. The host interface circuit 56 is further coupled to the host interface 20, the frame composer circuit 58, and the timer circuit 60.

The BB RX circuit 50 is generally configured to receive the RX_I and RX_Q signals, and to decode the signals into the corresponding bit stream, which the BB RX circuit 50 supplies to the host interface circuit 56. Similarly, the BB TX circuit 52 may be coupled to receive a bit stream for transmission, and to encode the bit stream onto the TX_I and TX_Q signals. The control circuit 54 may handle various other control functions, including generating the TXRX signal.

The host interface circuit 56 may generally include the circuitry for communicating on the host interface 20, including circuitry for performing DMA transfers to transfer frames to and from the system memory of the host computer system. The bit streams transmitted by the host interface circuit 56 may include frames transferred from the system memory, as well as other data that may be inserted by the frame composer circuit 58 (e.g. various header information for the packets). The bit streams received by the host interface circuit 56 may include the preamble (which may be stripped by the MAC 28) as well as frame data that may be transferred from system memory.

Generally, the frame composer circuit 58 may be configured to generate the frames to be transmitted on the wireless network. The frames may include preamble and header information inserted by the MAC 28, as well as the frame data read from the system memory. Some types of frames (such as some control and management frames defined in the IEEE 802.11 specifications) may be completely generated in the MAC 28. The timer 60 may comprise control logic for managing the channel, including handling various response time requirements and detecting times at which frames may be transmitted. Additional details regarding some embodiments of the MAC 28 may be found in U.S. Provisional Patent Application Ser. No. 60/343,737, filed Dec. 28, 2001 and in the following U.S. Patent Applications: Ser. No. 10/147,413, filed May 16, 2002; Ser. No. 10/147,426, filed May 22, 2002; and Ser. No. 10/147,425, filed May 16, 2002. These applications are incorporated herein by reference in their entireties, to the extent that no conflict exists between these applications and the present disclosure set forth herein. In the event of such conflict, then any such conflicting material in such incorporated by reference U.S. patent applications or U.S. provisional application is specifically not incorporated by reference herein.

FIG. 4 is a block diagram of one embodiment of a computer system 70 including the wireless networking card 10 as well as a bridge 72, a system memory 74, and a processor 76. The wireless networking card 10 is coupled to the bridge 72 using the host interface 20. The bridge 72 is further coupled to the system memory 74 and the processor 76.

The processor 76 may be any type of general purpose processor, implementing any desired instruction set. For example, the processor 76 may implement the x86 instruction set (optionally including 64 bit extensions thereto, known as AMD64, by Advanced Micro Devices, Inc.). Other embodiments may implement any other instruction set (e.g. PowerPC, MIPS, SPARC, ARM, etc.).

The system memory 74 is a memory in which application programs and data for used by the processor 76 are stored, and from which the processor 76 primarily executes. A suitable system memory 74 may comprise DRAM (Dynamic Random Access Memory). For example, a plurality of banks of SDRAM (Synchronous DRAM), double data rate (DDR) SDRAM, or Rambus DRAM (RDRAM), etc. may be suitable.

The bridge 72 is generally configured to provide an interface between the processor 76, the system memory 74, and devices attached to host interface 20 such as the wireless networking card 10. When an operation is received from one of the devices connected to the bridge 72, the bridge 72 identifies the target of the operation (e.g. a particular device or, in the case of host interface 20, that the target is on host interface 20). The bridge 72 routes the operation to the targeted device. The bridge 72 generally translates an operation from the protocol used by the source device or interface to the protocol used by the target device or interface.

While one processor 76 is shown in FIG. 4, other embodiments may include multiple processors 76. Furthermore, other embodiments may include various other devices (e.g. other I/O devices, disk drives, etc.) coupled to the bridge 72, to the host interface 20, or to a device coupled to the host interface 20.

In other embodiments, the bridge 72 may not be used. For example, in some embodiments, the processor 76 may include a host bridge and a host interface 20. Particularly, some embodiments may include a HyperTransport interface. Such embodiments may further integrate a memory controller into the processor 76, and the system memory 74 may be coupled to the processor 76. In still other embodiments, multiple processors 76 may be included and the system memory 74 may be distributed to two or more of the processors 76.

Numerous variations and modifications will become apparent to those skilled in the art once the above disclosure is fully appreciated. It is intended that the following claims be interpreted to embrace all such variations and modifications.

1. An apparatus comprising:
a first integrated circuit comprising:
transceiver hardware configured to transmit and receive analog signals;
one or more analog to digital converters coupled to the transceiver hardware, wherein the analog to digital converters are configured to convert one or more received analog signals from the transceiver hardware to one or more received digital signals; and
one or more digital to analog converters coupled to the transceiver hardware and to receive one or more transmitted digital signals, wherein the digital to analog converters are configured to convert the transmitted digital signals to transmitted analog signals for transmission by the transceiver hardware; and
a second integrated circuit configured to be coupled to the first integrated circuit, wherein the second integrated circuit comprises a baseband processor configured to process the received digital signals and to generate the transmitted digital signals.

2. The apparatus as recited in claim 1 wherein each of the first integrated circuit and the second integrated circuit are configured to couple to a digital interface to communicate between the first integrated circuit and the second integrated circuit.

3. The apparatus as recited in claim 2 wherein the digital interface comprises one or more transmit lines to communicate the one or more transmitted digital signals from the second integrated circuit to the first integrated circuit.

4. The apparatus as recited in claim 3 wherein the digital interface comprises one or more receive lines to communicate the one or more received digital signals from the first integrated circuit to the second integrated circuit.

5. The apparatus as recited in claim 1 wherein the received digital signals and the transmitted digital signals comprise in-phase and quadrature signals.

6. The apparatus as recited in claim 1 wherein the first integrated circuit further comprises an automatic gain control circuit coupled to the transceiver hardware, wherein the automatic gain control circuit is configured to control gain in the transceiver hardware.

7. The apparatus as recited in claim 6 wherein the transceiver circuit comprises a low noise amplifier coupled to receive an analog signal and amplify the analog signal, wherein the automatic gain control circuit is configured to control a gain of the low noise amplifier.

8. The apparatus as recited in claim 6 wherein the transceiver circuit comprises one or more filter circuits, wherein the automatic gain control circuit is coupled to at least one of the one or more filter circuits and is configured to control the one or more filter circuits.

9. The apparatus as recited in claim 1 wherein the received analog signals and the transmitted analog signals comprise frames on a wireless network.

10. The apparatus as recited in claim 9 wherein the second integrated circuit comprises a media access controller for the frames.

11. The apparatus as recited in claim 1 wherein the transceiver is configured to wirelessly transmit and receive analog signals.

12. An apparatus comprising:
a digital interface;
a first integrated circuit coupled to the digital interface, the first integrated circuit comprising transceiver hardware configured to transmit and receive analog signals, and wherein the first integrated circuit is configured to transmit and receive corresponding digital signals on the digital interface;
a second integrated circuit coupled to the digital interface, wherein the second integrated circuit comprises a baseband processor configured to process one or more digital signals received on the digital interface from the first integrated circuit and to transmit one or more digital signals on the digital interface to the first integrated circuit.

13. The apparatus as recited in claim 12 wherein the first integrated circuit further comprises one or more analog to digital converters coupled to the transceiver hardware, wherein the analog to digital converters are configured to convert one or more received analog signals from the transceiver hardware to one or more received digital signals for transmission on the digital interface.

14. The apparatus as recited in claim 12 wherein the first integrated circuit further comprises one or more digital to analog converters coupled to the transceiver hardware and to receive one or more transmitted digital signals from the digital interface, wherein the digital to analog converters are configured to convert the transmitted digital signals to transmitted analog signals for transmission by the transceiver hardware.

15. The apparatus as recited in claim 12 wherein the digital interface comprises one or more transmit lines to communicate one or more transmitted digital signals from the second integrated circuit to the first integrated circuit.

16. The apparatus as recited in claim 15 wherein the digital interface comprises one or more receive lines to communicate one or more received digital signals from the first integrated circuit to the second integrated circuit.

17. The apparatus as recited in claim 12 wherein the analog signals comprise frames on a wireless network.

18. The apparatus as recited in claim 17 wherein the second integrated circuit comprises a media access controller for the frames.

19. The apparatus as recited in claim 12 wherein the transceiver is configured to wirelessly transmit and receive analog signals.
